(19) United States
(12) Patent Application Publication
(10) Pub. No.: US 2024/0251481 A1
(43) Pub. Date: Jul. 25, 2024

(54) VAPORISATION DEVICE FOR AN INHALER

(71) Applicant: KÖRBER TECHNOLOGIES GMBH, Hamburg (DE)

(72) Inventors: Eiko BÄUMKER, FREIBURG (DE); Thomas BILGER, BUGGINGEN (DE); Muhannad GHANAM, FREIBURG (DE); Timo GERACH, TENINGEN (DE); Uwe PELZ, NAUENBURG (DE); Mohammadreza SABERI, FREIBURG (DE); Peter WOIAS, FREIBURG (DE); Luca CONRAD, FREIBURG (DE); Frank GOLDSCHMIDTBÖING, ORTENBERG (DE)

(21) Appl. No.: 18/563,611

(22) PCT Filed: May 30, 2022
(86) PCT No.: PCT/EP2022/064548

§ 371 Date: Nov. 22, 2023

(30) Foreign Application Priority Data
Jun. 2, 2021 (DE) 10 2021 114 281.4

(51) Int. Cl. H05B 3/14; A24F 40/10; A24F 40/46

(52) U.S. Cl. CPC H05B 3/148; A24F 40/10; A24F 40/46; H05B 2203/021

(57) ABSTRACT

A vaporisation device for an inhalator comprising an electrical resistance heating element for the vaporisation of liquid brought into contact with the resistance heating element by means of electrical energy. The resistance heating element consists of a material in which the resistance change per temperature interval, in a temperature range around a vaporisation temperature, is at least three times as large as in a temperature range around room temperature.

The present invention is in relation to a vaporisation device for an inhalator, comprising an electrical resistance heating element for the vaporisation of liquid brought into contact with the resistance heating element by means of electrical energy.

An inhalator of this type is for example known from DE 10 2017 123 868 B4, DE 10 2017 123 869 B4 and DE 10 2017 123 870 B4.

The regulation of the electrical heating power or the heating temperature of a vaporiser in the form of a resistance heating element is desirable in order to achieve a consistent or adjustable amount of vapour and to prevent the increased formation of pollutants at elevated temperatures. Different methods for the regulation of heating elements are known, for example see DE 10 2019 113 645 B4. These can essentially be categorised into methods of temperature regulation and power regulation. Both methods are subject to specific challenges when a starting temperature of the heating element or the liquid varies greatly.

The invention is based on the object, proceeding from the prior art, of providing a device and a method for an inhalator, which despite tolerance-affected resistance of the heating element, enables a determination of the heating element temperature with a tolerance which is significantly lower than the tolerance of the starting temperatures.

The invention solves the object with the features of the independent claims. According to the invention, the resistance heating element consists of a material in which the resistance change per temperature interval is at least three times as large in a temperature range around a vaporisation temperature as in a temperature range around room temperature. A temperature range around a vaporisation temperature is a temperature range which comprises at least a mean vaporisation temperature (for example 250° C.) and the lower limit of which is above 100° C. A temperature range around room temperature is a temperature range which comprises room temperature (25° C.) and the upper limit of which is below 100° C.

For clarification of the underlying problem, firstly three cases are considered: a normal case with a heating element and liquid temperature of for example T₀=25° C. (room temperature), a low temperature case with for example T₀=−20° C. (for example outside temperature during extreme winter) and a high temperature case with for example T₀=50° C. (for example inhalator located in the sun). A temperature sensor for measuring the heating element temperature is advantageously not provided, as the sensor and the electrical contacts for the evaluation of the sensor would fundamentally increase the cost of the vaporisation device. For measuring the temperature therefore only the electrical resistance of the heating element itself is provided. Here, the temperature increase is calculated from the relative increase in resistance compared to the starting resistance or from the absolute resistance of the heating element.

For heating elements made of p-doped silicon, the relative resistance change per temperature is approximately 0.2%/K, the basic resistance of a heating element is approximately 1Ω. At a tolerance of the basic resistance of 18 mΩ and the parasitic supply line resistances of 18 mΩ, the maximum measurement error when using the absolute resistance value would correspond to 57 K and would therefore not be acceptable. The application of the relative resistance change related to the starting resistance would result in a tolerance window of only 7.7 K. Consequently, a relative method is used advantageously for the temperature measurement. The temperature value therefore is advantageously calculated from the current resistance R_{cur} and the resistance R₀ at the beginning of the heating process. This leads however to a problem if the starting temperature T₀ is not known, as this unknown quantity (70 K in the mentioned example) also affects the measurement result.

In the case of a power regulation or power control, if necessary with shutdown at too high temperatures for the avoidance of excessive pollutants, the same problem occurs in principle. The shutdown at too high temperatures can only then occur if the temperature can be sufficiently accurately determined. Furthermore, the amount of vapour generated also depends on the surrounding temperature. At low temperatures (for example 20° C.), more energy has to be used in order to heat the liquid up to the vaporisation point, in addition the heat losses to the surroundings are higher. Overall, the amount of vapour generated at the same heating power is therefore significantly lower than at high starting temperatures (for example 50° C.).

According to the invention, a heating element is used that exhibits a comparably low resistance change in the tolerance range of the starting temperature (here for example −20° C. to +50° C.) and has a comparably high resistance change with the temperature in the range of the vaporisation temperature (here for example 200° C. to 300° C.). More accurately, the resistance change per temperature interval in a temperature range around a vaporisation temperature is three times as large, preferably at least five time as large, further preferably at least seven times as large, as in a temperature range around room temperature. In this manner the starting resistance R₀ of the heating element is fundamentally independent of the temperature, or at least significantly less temperature-dependent, so that the tolerance of the starting temperature has only a low or very low influence on the measured temperature in the range of the vaporisation temperature.

A corresponding resistance characteristic curve can be achieved by using a material for the heating element with suitable temperature dependence of the specific resistance. Such a material is boron-doped silicon, for example at a dopant concentration in the range of 4·10¹⁸/cm³. In this range, boron-doped silicon exhibits an almost constant specific resistance in the range from, for example, −20° C. to +50° C. and a significantly stronger and advantageously even largely linear temperature dependence in the measuring range (here, for example, greater than 200° C.). A linear temperature dependence of the material in the range of the vaporisation or operating temperature simplifies the determination of the temperature and is therefore preferable. In general, a monotonic temperature dependence is sufficient so that every resistance value can be clearly assigned a temperature; a strictly linear temperature dependence is therefore not absolutely necessary.

It is conceivable to achieve a suitable temperature dependence of the specific resistance with other doped semiconductors, for example thallium doping or arsenic doping of a semiconductor such as for example silicon.

Preferably, the doping is at least 10¹⁶/cm³, preferably at least 10¹⁷/cm³ or further preferably at least 10¹⁸/cm³. A sufficient and suitable doping strength is important for the achievement of the desired temperature dependence of the specific resistance of the heating element. The doping generally depends on the semiconductor material and the doping material (foreign atoms).

Preferably, the relative resistance change of the heating element material per temperature interval is at least 10% per 100 K in a temperature range around a vaporisation temperature. Preferably, the relative resistance change of the heating element material per temperature interval is at most 3.5% per 100 K in a temperature range around room temperature.

The invention is explained in the following using preferred embodiments with reference to the appended figures, which show:

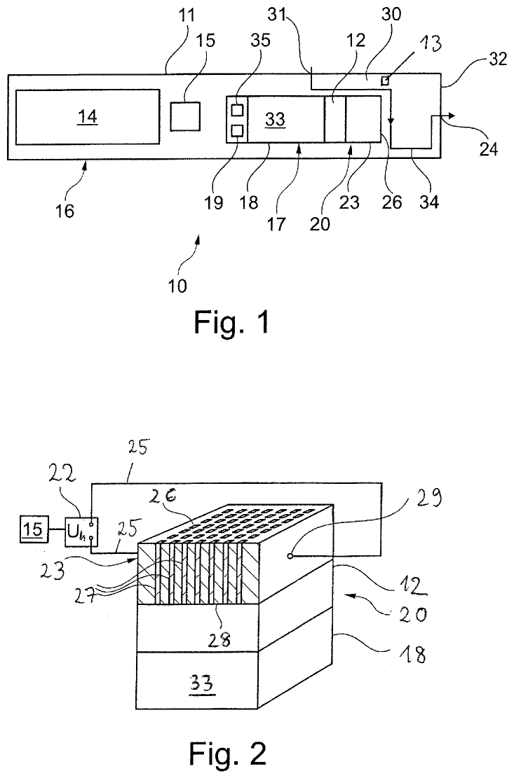

FIG. 1 a schematic view of an electronic inhalator;

FIG. 2 a perspective view of a vaporisation device for an inhalator;

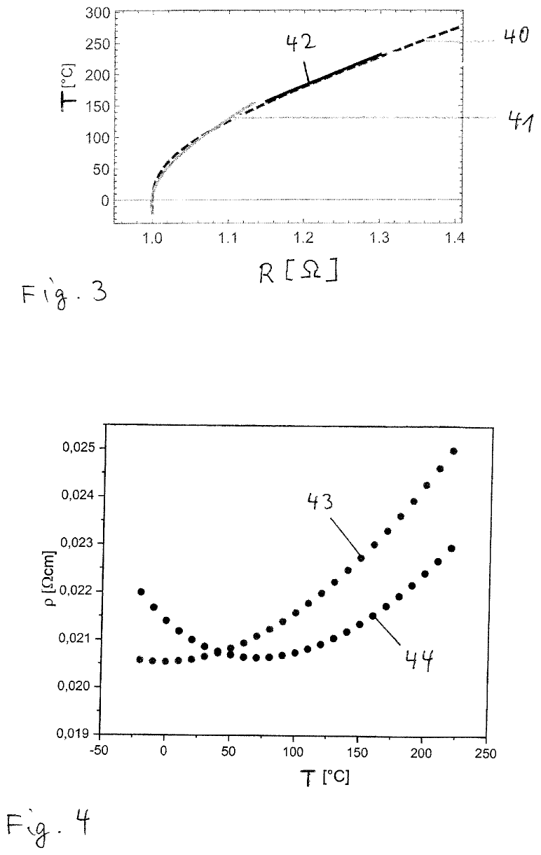

FIG. 3 a temperature characteristic curve of a heating element made of a material according to the invention;

FIG. 4 theoretical temperature dependences of the specific resistance of two materials in comparison;

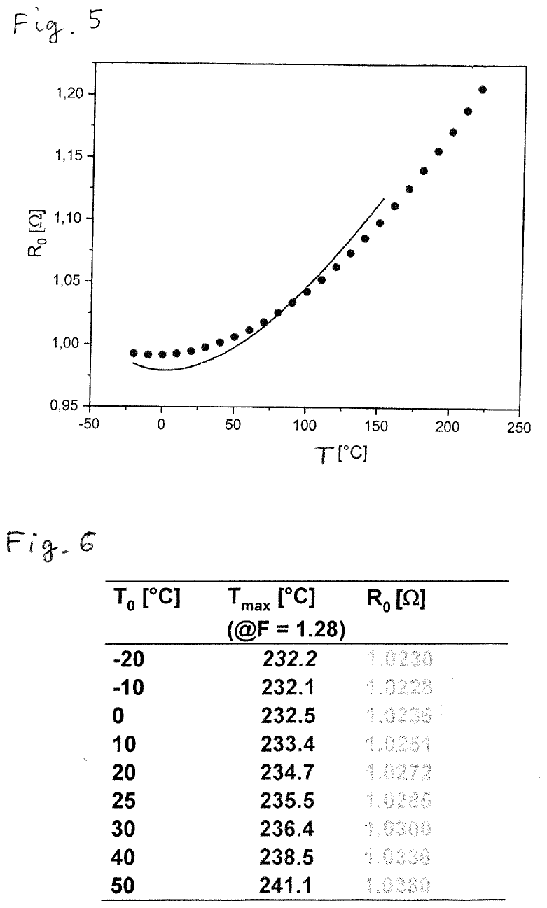

FIG. 5 a measurement curve of the resistance of a heating element made of boron-doped silicon together with theoretically calculated values; and

FIG. 6 a table with columns showing starting temperature, temperature at achievement of 1.28 times the starting resistance, and resistance at the starting temperature.

The electronic inhalator 10, here an electronic cigarette product, comprises a housing 11, in which an air channel 30 between at least one air inlet opening 31 and one air outlet opening 24 is provided on a mouth end 32 of the cigarette product 10. The mouth end 32 of the cigarette product 10 refers in this case to the end on which the consumer draws for the purposes of inhalation and therefore impinges on the cigarette product 10 with a negative pressure and generates an air flow 34 in the air channel 30.

The inhalator 10 comprises a vaporisation device 20 and a liquid reservoir 18, which for example can be part of an interchangeable vaporiser cartridge 17. The air sucked in via the inlet opening 31 is guided along in the air channel 30 as air flow 34 to the, through the or in the vaporisation device 20. The vaporisation device 20 is connected or connectible with the liquid reservoir 18 in which at least one liquid 33 is stored. The vaporisation device 20 vaporises liquid 33 which is guided from the liquid reservoir 18, and admits the vaporised liquid as an aerosol/vapour on an outlet side 26 of the vaporisation device 20 into the air flow 34. The liquid 33 to be dosed that is stored in the liquid reservoir 18 is for example a mixture comprising one or more of the following components in an arbitrary combination: 1,2-propylene glycol, glycerol, water, at least one aroma (flavour). The liquid can contain at least one active ingredient, for example nicotine.

The electronic cigarette 10 comprises furthermore an electrical energy storage 14 and an electronic control device 15, which for example can be arranged in a base portion 16 of the inhalator 10. The energy storage 14 can be in particular an electrochemical disposable battery or a rechargeable electrochemical battery, for example a lithium-ion battery. In the example shown in FIG. 1, the energy storage 14 is arranged in a portion facing away from the mouth end 32 of the inhalator 10. The vaporisation cartridge 17 is arranged advantageously between the energy storage 14 and the mouth end 32. The electronic control device 15 is advantageously digital and comprises preferably a microprocessor and/or micro-controller.

A sensor 13, for example a pressure sensor or a pressure or flow switch, is advantageously located in the housing 11, wherein the control device 15 can determine, based on a sensor signal emitted from the sensor 13, that a consumer draws on the mouth end 32 of the inhalator in order to inhale. In this case, the control device 15 controls the vaporisation device 20 in order to admit liquid 33 from the liquid reservoir 18 as an aerosol/vapour into the air flow 34.

The vaporisation device 20 comprises at least one vaporiser in the form of a resistance heating element 23 (see FIG. 2) and advantageously a capillary element 12 for the delivery of liquid 33 from the liquid reservoir 18 to the heating element 23. In the operating state of the inhalator 10, the heating element 23 is connected electrically via electric conductors 25 to a heating voltage source 22 that can be controlled by the electronic control device 15. The heating voltage source 22 is preferably connected via electrodes 29 on opposite sides of the heating element 23 to the latter, so that an electrical heating voltage Uh, generated by the heating voltage source 22, leads to a current flow through the heating element 23. The heating voltage source 22 gets electrical energy from the electrical energy storage 14. On the basis of the ohmic resistance of the electrically conductive heating element 23, the current flow leads to a heating of the heating element 23 and therefore to a vaporisation of liquid contained in the micro-channels 27. Thus, the heating element 23 operates as a vaporiser. In this way, generated vapour/aerosol escapes from the micro-channels 27 to the outlet side 26 and is mixed with the air flow 34, see FIG. 1. More precisely, the control device 15 controls the heating voltage source 22 on determination of an air flow 34, caused by the draw of the consumer, through the air channel 30, whereby liquid located in the micro-channels 27 is driven from the micro-channels 27 in the form of vapour/aerosol by spontaneous heating.

The inhalator 10 comprises advantageously a digital data storage 35 for saving information or parameters in relation to the vaporisation cartridge 17. The data storage 35 can be part of or connected to the electronic control device 15. Information about the composition of the liquid stored in the liquid reservoir 18, information about the process profile, in particular power/temperature regulation; data for the condition monitoring or system checking, for example leak detection; data in relation to copyright protection and counterfeit protection, an ID for the unique identification of the vaporisation cartridge 17, serial number, production date and/or expiration date, and/or puff count (number of inhalation draws by the consumer) or the use time, is saved advantageously in the data storage 35.

The heating element 23 is provided with a multiplicity of micro-channels 27 which connect an inlet side 28 of the heating element 23 with an outlet side 26 in a fluidically conductive manner. The inlet side 28 is connected with the liquid reservoir 18 via a capillary element 12 in a fluidically conductive manner. The capillary element 12 serves for the passive advancement of liquid 33 to be vaporised from a liquid reservoir 18 to the heating element 23 by means of capillary forces. The capillary element 12 consists advantageously of a non-conductive material, in order to avoid the undesired heating of liquid in the capillary element 12 by current flow.

The average diameter of the micro-channels 27 preferably lies in the range between 5 μm and 200 μm, further preferably in the range between 30 μm and 118 μm, still more preferably in the range between 18 μm and 100 μm. On the basis of these dimensions, a capillary action is advantageously generated, so that liquid entering into a micro-channel 27 on the inlet side 28 rises to the top through the micro-channel 27 until the micro-channel 27 is filled with liquid. The volume ratio of micro-channels 27 to heating element 23, which can be referred to as porosity of the heating element 23, is for example in the range between 10% and 18%, advantageously in the range between 15% and 40%, further advantageously in the range between 20% and 30%, and is for example 25%. The thickness of the heating element 23 and therefore the length of the micro-channels 27 is preferably in the range between 0.05 mm and 1 mm, more preferably in the range between 0.1 mm and 0.75 mm, further preferably in the range between 0.2 mm and 0.5 mm, and is for example 0.3 mm.

The heating element 23 is preferably block-shaped, for example cuboid-shaped, and preferably monolithic, i.e., the heating element 23 does not have advantageously any macroscopic cavities apart from the micro-channels 27. The heating element 23 can therefore be referred to as a block, bulk, or volume heating element.

The vaporisation temperature is preferably in the range between 100° C. and 400° C., more preferably between 150° C. and 318° C., again more preferably between 190° C. and 240° C.

The vaporisation device 20 has an electronic measuring circuit 19 for the determination of the temperature of the heating element 23 by measuring the electric resistance of the heating element 23. Circuits for measuring the electrical resistance of a heating element through which current flows are known per se.

For the heating element 23 a material is used that exhibits a comparatively low resistance change with the temperature in the tolerance range of the starting temperature, here for example −20° C. to +50° C., and has a comparatively high resistance change with the temperature in the range of the vaporisation temperature, here for example 200° C. to 300° C.

FIG. 3 shows an example of such a temperature characteristic curve of a heating element 23 according to the invention. There, the temperature in ° C. is plotted against the total resistance of the heating element 23 in Ohms. The dashed curve 40 shows illustratively a fit curve as the basis of the calculation. The solid line 41 at low temperatures reflects a measurement in a climate chamber. The solid line 42 at higher temperatures reflects a measurement with an infra-red camera in the case of resistance heating of the heating element 23. The resistance of the heating element 23 only changes by about 20 mΩ (1.01±0.01 0) in the range of the starting temperature between −20° C. and +50° C. In the range of the vaporisation temperature, here between 150° C. and 250° C., the resistance of the heating element 23 changes significantly by about 210 mΩ (1.14-1.35Ω). The resistance change per temperature interval in a temperature range around a vaporisation temperature related to the resistance change per temperature interval in a temperature range around room temperature is therefore in this example (210 mΩ/100° C.)/(20 mΩ/70° C.)=7.35. In this way, the starting resistance R₀ of the heating element 23 is fundamentally independent of the temperature, or at least significantly less temperature-dependent, so that the tolerance of the starting temperature only has a low or very low influence on the measured temperature in the range of the vaporisation temperature.

A corresponding resistance characteristic curve can be achieved by using a material for the heating element 23 with suitable temperature dependence of the specific resistance. The heating element 23 consists advantageously of an electrically conductive, doped semiconductor material, preferably doped silicon. In a particularly preferred embodiment, the material of the heating element is boron-doped silicon. The boron doping strength is for example in the range between 10¹⁸/cm³ and 10¹⁹/cm³ and amounts to 4·10¹⁸/cm³.

The theoretical temperature dependencies of the specific resistance of the boron-doped silicon 43 are shown in comparison to the phosphorus-doped silicon 44 in FIG. 4. Here, the specific resistance ρ in Ω·cm is plotted against the temperature of the heating element 23 in 0C. The boron-doped silicon (dots 43) exhibits an almost constant specific resistance in the range from −20° C. to +50° C. and a mostly linear temperature dependence in the measurement range (here greater than 200° C.). Phosphorus-doped silicon (dots 44) is however not suitable, as the specific resistance is highly changeable in the range from −20° C. to +50° C.

FIG. 5 shows a measurement curve of the resistance of a heating element 23 made of boron-doped silicon (solid line) together with the value calculated from the theoretical trajectory (dots) of the specific resistance. Both curves are located near each other and have a very similar trajectory.

The table in FIG. 6 shows for nine values of the starting temperature T₀ in the range −20° C. to +50° C., the temperature Tₘₐₓ on the achievement of 1.28 times the starting resistance and the starting resistance R₀ in Ohms. It is apparent from the table that for the curve shown in FIG. 3, a tolerance of the temperature determination of only approx. 9 K occurs when the tolerance of the starting temperature is 70 K.

1. A vaporisation device for an inhalator, comprising an electrical resistance heating element for the vaporisation of liquid brought into contact with the resistance heating element by means of electrical energy, wherein the resistance heating element consists of a material in which the resistance change per temperature interval is at least three times as large in a temperature range around a vaporisation temperature as in a temperature range around room temperature.

2. The vaporisation device according to claim 1, wherein, in the case of the material of the resistance heating element in a temperature range around a vaporisation temperature, the resistance change per temperature interval is at least five times as large as in a temperature range around room temperature.

3. The vaporisation device according to claim 1, wherein the material of the resistance heating element has a monotonic resistance change with the temperature in a range around a vaporisation temperature.

4. The vaporisation device according to claim 1, wherein the material of the resistance heating element has an approximately linear resistance change with the temperature in a range around a vaporisation temperature.

5. The vaporisation device according to claim 1, wherein the material of the resistance heating element is a doped semiconductive material.

6. The vaporisation device according to claim 5, wherein the semiconductive material has a boron doping.

7. The vaporisation device according to claim 5, wherein the semiconductive material has a thallium doping and/or an arsenic doping.

8. The vaporisation device according to claim 5, wherein the doping of the heating element amounts to at least 10¹⁶/cm³.

9. The vaporisation device according to claim 1, wherein the relative resistance change of the heating element per temperature interval, in a temperature range around a vaporisation temperature, amounts to at least 10% per 100 K.

10. The vaporisation device according to claim 1, wherein the relative resistance change of the heating element per temperature interval, in a temperature range around room temperature, amounts to at most 3.5% per 100 K.

11. The vaporisation device according to claim 1, wherein, in the case of the material of the resistance heating element in a temperature range around a vaporisation temperature, the resistance change per temperature interval is at least seven times as large as in a temperature range around room temperature.

12. The vaporisation device according to claim 5, wherein the doped semiconductive material is doped silicon.

13. The vaporisation device according to claim 8, wherein the doping of the heating element amounts to at least 10¹⁷/cm³.

14. The vaporisation device according to claim 8, wherein the doping of the heating element amounts to at least 10¹⁸/cm³.
